(19) United States
(12) Patent Application Publication
(10) Pub. No.: US 2024/0220270 A1
(43) Pub. Date: Jul. 4, 2024

(54) DATA-ANALYSIS-BASED CONSOLIDATION OF PROCESS PIPELINES

(71) Applicant: INTERNATIONAL BUSINESS MACHINES CORPORATION, Armonk, NY (US)

(72) Inventors: Lukasz G. CMIELOWSKI, Krakow (PL); Szymon KUCHARCZYK, Krakow (PL); Daniel Jakub RYSZKA, Krakow (PL); Wojciech SOBALA, Krakow (PL)

(21) Appl. No.: 18/149,227

(22) Filed: Jan. 3, 2023

(51) Int. Cl. G06F 9/38; G06F 9/30

(52) U.S. Cl. CPC G06F 9/3867; G06F 9/30181

(57) ABSTRACT

Processing within a computing environment is facilitated by determining a correlation quantity indicative of similarity between respective nodes of processing pipelines of the computing environment. Consolidating of respective nodes of the process pipelines is initiated where the correlation quantity has a predefined relationship with a correlation threshold for consolidating nodes of the process pipelines within the computing environment.

### BACKGROUND

One or more aspects relate, in general, to facilitating processing within a computing environment, and in particular, to facilitating consolidating of selected nodes of process pipelines of the computing environment to reduce complexity and enhance processing within the computing environment.

Pipeline processing within a computing environment is a processing approach where multiple instructions (i.e., nodes, processing segments, stages, steps) are overlapped during executing. A pipeline process can include one or more nodes or stages of the pipeline being performed simultaneously. In a pipeline process, the process is divided into a sequential process of smaller fragments or sub-operations. The execution of the sub-operations takes place in a dedicated segment or node that functions together with other segments. Thus, a pipeline has a collection of nodes or processing segments which, for instance, facilitate the flow of binary information within the computing environment. In one or more embodiments, the outcome of one segment of the pipeline is conveyed to the next segment in the pipeline until a desired result is obtained. The term pipeline indicates that the flow of information takes place in parallel. The overlapping of processing can be accomplished by relating a register to each segment in the pipeline. The registers facilitate providing isolation between the different instruction segments so that multiple segments can work on distinct data simultaneously. In one or more implementations, a node or segment can include an input register and a combinational logic. The register stores the information, and the combinational logic operates on the specific instruction segment. The output of the combinatorial logic can be sent to the input register of the next segment, and activities of the segments can be performed via a clock being set for each register.

### SUMMARY

Certain shortcomings of the prior art are overcome, and additional advantages are provided through the provision of a computer-implemented method of facilitating processing within a computing environment. The computer-implemented method includes determining a correlation quantity indicative of similarity between respective nodes of process pipelines of the computing environment. Further, the method includes initiating consolidating of the respective nodes of the process pipelines based on the correlation quantity having a predefined relationship with a correlation threshold for consolidating nodes of the process pipelines within the computing environment.

Computer systems and computer program products relating to one or more aspects are also described and claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to include and/or use one or more aspects of the present invention;

FIG. 2 depicts one embodiment of a computer program product with a pipeline processing consolidation module, in accordance with one or more aspects of the present invention;

FIG. 3 depicts one embodiment of a pipeline consolidation process, in accordance with one or more aspects of the present invention;

FIG. 4A depicts one example of a process pipeline to undergo consolidation processing, in accordance with one or more aspects of the present invention;

FIG. 4B is a data structure representing the pipeline of FIG. 4A split into sub-pipelines consisting of n-ordered nodes of the original pipeline to facilitate consolidation processing, in accordance with one or more aspects of the present invention;

FIG. 5A depicts a data structure mapping sub-pipelines to respective numerical values to facilitate consolidation processing, in accordance with one or more aspects of the present invention;

FIG. 5B is a further data structure representative of encoding of sub-pipelines of process pipelines to facilitate consolidation processing, in accordance with one or more aspects of the present invention;

FIG. 6 is a further example of a computing environment to include and/or use one or more aspects of the present invention; and

FIGS. 7A-7D depict a further example of pipeline processing consolidation, in accordance with one or more aspects of the present invention.

### DETAILED DESCRIPTION

The accompanying figures, which are incorporated in and form a part of this specification, further illustrate the present invention and, together with this detailed description of the invention, serve to explain aspects of the present invention. Note in this regard that descriptions of well-known systems, devices, processing techniques, etc., are omitted so as to not unnecessarily obscure the invention in detail. It should be understood, however, that the detailed description and this specific example(s), while indicating aspects of the invention, are given by way of illustration only, and not limitation. Various substitutions, modifications, additions, and/or other arrangements, within the spirit or scope of the underlying inventive concepts will be apparent to those skilled in the art from this disclosure. Note further that numerous inventive aspects or features are disclosed herein, and unless inconsistent, each disclosed aspect or feature is combinable with any other disclosed aspect or feature as desired for a particular application of the concepts disclosed.

Note also that illustrative embodiments are described below using specific code, designs, architectures, protocols, layouts, schematics, or tools only as examples, and not by way of limitation. Furthermore, the illustrative embodiments are described in certain instances using particular software, hardware, tools, or data processing environments only as example for clarity of description. The illustrative embodiments can be used in conjunction with other comparable or similarly purposed structures, systems, applications, or architectures. One or more aspects of an illustrative embodiment can be implemented in software, hardware, or a combination thereof.

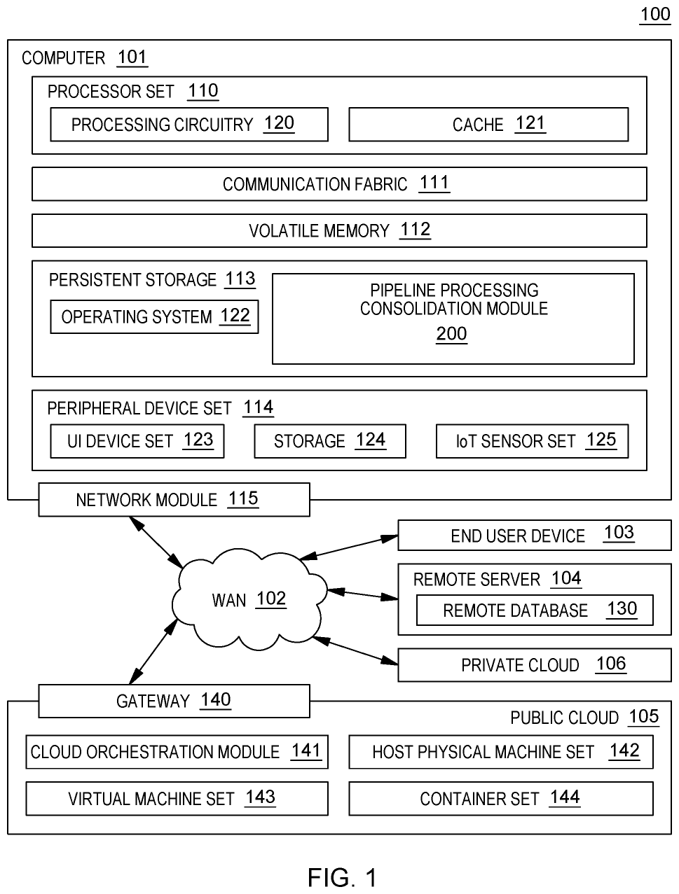

As understood by one skilled in the art, program code, as referred to in this application, can include software and/or hardware. For example, program code in certain embodiments of the present invention can utilize a software-based implementation of the functions described, while other embodiments can include fixed function hardware. Certain embodiments combine both types of program code. Examples of program code, also referred to as one or more programs, are depicted in FIG. 1, including operating system 122 and pipeline processing consolidation module 200, which are stored in persistent storage 113.

One or more aspects of the present invention are incorporated in, performed and/or used by a computing environment. As examples, the computing environment can be of various architectures and of various types, including, but not limited to: personal computing, client-server, distributed, virtual, emulated, partitioned, non-partitioned, cloud-based, quantum, grid, time-sharing, clustered, peer-to-peer, mobile, having one node or multiple nodes, having one processor or multiple processors, and/or any other type of environment and/or configuration, etc., that is capable of executing a process (or multiple processes) that, e.g., perform automated container name identification processing, such as disclosed herein. Aspects of the present invention are not limited to a particular architecture or environment.

Prior to further describing detailed embodiments of the present invention, an example of a computing environment to include and/or use one or more aspects of the present invention is discussed below with reference to FIG. 1.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as pipeline processing consolidation module block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 126 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The computing environment described above is only one example of a computing environment to incorporate, perform and/or use one or more aspects of the present invention. Other examples are possible. Further, in one or more embodiments, one or more of the components/modules of FIG. 1 need not be included in the computing environment and/or are not used for one or more aspects of the present invention. Further, in one or more embodiments, additional and/or other components/modules can be used. Other variations are possible.

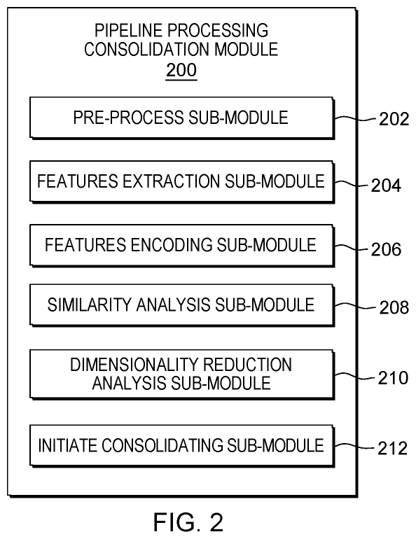

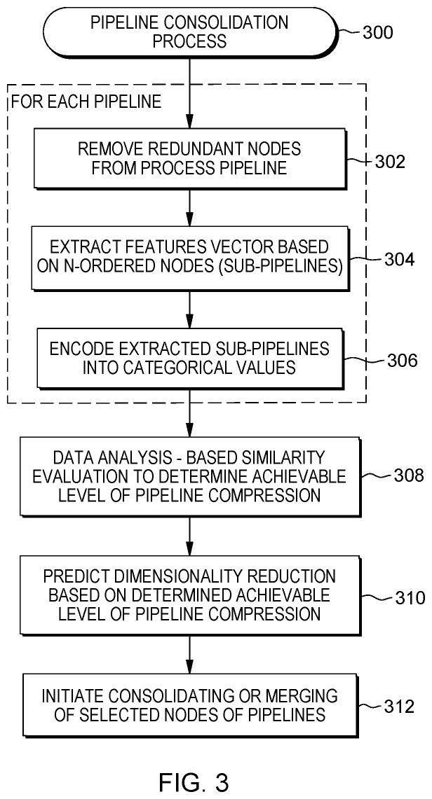

By way of example, one or more embodiments of a pipeline processing consolidation module and process are described initially with reference to FIGS. 2-3. FIG. 2 depicts one embodiment of pipeline processing consolidation module 200 that includes code or instructions used to perform pipeline simplification processing, in accordance with one or more aspects of the present invention, and FIG. 3 depicts one embodiment of a pipeline consolidation process, in accordance with one or more aspects of the present invention.

Note that, as used herein, a node (i.e., stage, step, processing segment) is one or more instructions or processing segments that perform an isolated action, and that can accept one or more inputs and return one or more outputs. In one or more implementations, nodes can be organized in ordered graphs and/or pipelines. A pipeline refers to a set of nodes (i.e., stages, steps, processing segments, etc.), which are mainly used in transformation processes, but that also can contain input nodes, output nodes, and other static nodes. The pipeline process refines or modifies data, creates a machine learning model with preprocessing steps, etc. As used herein, a sub-pipeline is a continuous part of the pipeline, containing a subset of the nodes in ordered form from the original pipeline. In one or more implementations, a sub-pipeline does not include input or output nodes (i.e., sources and sinks of data).

Referring to FIGS. 1 & 2, pipeline processing consolidation module 200 includes, in one example, various sub-modules used to perform automated pipeline consolidation processing, in accordance with one or more aspects of the present invention. The sub-modules are, e.g., computer-readable program code (e.g., instructions) and computer-readable media (e.g., persistent storage (e.g., persistent storage 113, such as a disk) and/or a cache (e.g., cache 121), as examples). The computer-readable media can be part of a computer program product and can be executed by and/or using one or more computers, such as computer(s) 101; processors, such as a processor of processor set 110; and/or processing circuitry, such as processing circuitry of processor set 110, etc.

In the FIG. 2 embodiment, example sub-modules of pipeline processing consolidation module 200 include, for instance, a pre-process sub-module 202 to remove redundant nodes of the process pipelines being evaluated, such as input nodes, output nodes, static nodes, etc.; a features extraction sub-module 204 for splitting each pipeline into sub-pipelines consisting of n-ordered nodes of the original pipeline, where n is a length of the sub-pipeline; a features encoding sub-module 206 to encode the extracted sub-pipelines of n-ordered nodes into categorical values; a similarity analysis sub-module 208 to determine a correlation quantity indicative of similarity between respective nodes of sub-pipelines of the process pipelines; a dimensionality reduction analysis sub-module 210 to determine process dimensionality reduction based on a determined achievable level of pipeline compression through merging of selected nodes of the sub-pipelines; and an initiate consolidating sub-module 212 which can use, in one embodiment, unsupervised machine-learning-based analysis to identify and facilitate consolidating or merging of groups of pipelines using the determined similarity analysis results to remove unnecessary, or redundant, complexity from the process pipelines. Advantageously, consolidating selected nodes of the process pipelines advantageously facilitates pipeline processing within the computing environment by reducing the processing overhead. Note that although various sub-modules are described, automated container name identification module processing such as disclosed herein can use, or include, additional, fewer, and/or different sub-modules. A particular sub-module can include additional code, including code of other sub-modules, or less code. Further, additional and/or other modules can be used. Many variations are possible.

In one or more embodiments, the sub-modules are used, in accordance with one or more aspects of the present invention, to perform pipeline processing consolidation. FIG. 3 depicts one example of an automated pipeline processing consolidation process, such as disclosed herein. The process is executed, in one or more examples, by a computer (e.g., computer 101 (FIG. 1)), and/or a processor or processing circuitry (e.g., of processor set 110 of FIG. 1). In one example, code or instructions implementing the process, are part of a module, such as pipeline processing consolidation module 200. In other examples, the code can be included in one or more other modules and/or in one or more sub-modules of the one or more other modules. Various options are available.

As one example, pipeline consolidation process 300 executing on a computer (e.g., computer 101 of FIG. 1), a processor (e.g., a processor of processor set 110 of FIG. 1), and/or processing circuitry (e.g., processing circuitry of processor set 110), removes redundant nodes from each pipeline of multiple process pipelines being evaluated for possible simplification 302. Removal of redundant nodes can include a preprocessor cleanup stage of the system, where redundant nodes are, for instance, nodes such as input nodes, output nodes, static nodes (e.g., nodes that pass data from one node to another without transformation), and/or other nodes predefined by a user which do not transform data. Generally, redundant nodes are nodes not related to, for instance, data transformation within the pipeline. Note that the process pipeline is typically a combination of transformation nodes (stages) and special nodes, such as input nodes, output nodes, nodes to create a machine learning model with preprocessing steps, etc. The removal of redundant nodes is, in one or more embodiments, a preprocessing cleanup stage to remove certain types of nodes from the disclosed optimization process, such as input nodes (data source nodes), output nodes, static nodes, etc. In one embodiment, a list of redundant nodes to be removed or skipped can be defined and applied depending on a product's needs and requirements.

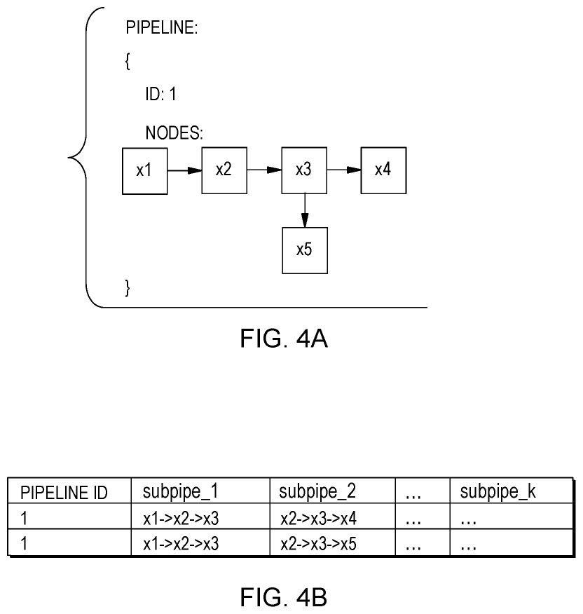

As illustrated in FIG. 3, for each pipeline, a features vector is extracted based on determined sub-pipelines consisting of n-ordered nodes of the pipeline 304. This stage of the process is responsible for converting the pipeline's nodes or stages into a features vector, while maintaining the ordering of the nodes. This advantageously reduces the pipeline dimensionality by reducing or compressing multiple nodes into a single entity, that can be represented as one joint step within the pipeline. By way of example, FIG. 4A illustrates a pipeline schema, which includes transformational nodes x1, x2, x3, x4, and x5. In one example only, node x1 can be (for instance) a filter stage, node x2 a merge stage, and node x3 a join stage, with the pipeline being identified with pipeline ID 1 in FIG. 4A, as an example.

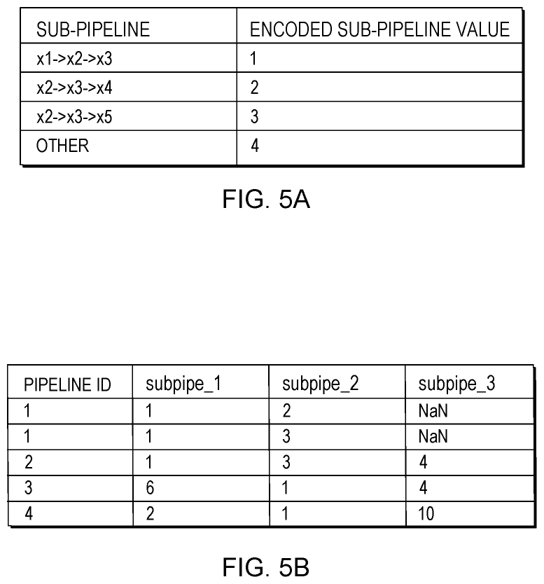

Extracting the features vector can include, in one embodiment, converting each process pipeline to be evaluated into a respective features vector of sub-pipelines, with each sub-pipeline including multiple nodes of the process pipeline. For instance, each pipeline is split into sub-pipelines consisting of n-ordered nodes (i.e., stages or steps) of the original pipeline, where n is the length of the sub-pipeline. In general, n should be an integer ≥3. Further, n should be less than or equal to the number of nodes in the shortest pipeline(s) in the analyzed set of process pipelines. In the example of FIGS. 4A-5B, n=3. In one or more embodiments, the list of possible sub-pipelines of pipeline ID 1 is therefore:
x1→x2→x3
x2→x3→x4
x2→x3→x5.

In a next step, the features vector of sub-pipelines is created. In one embodiment, where process pipelines with multiple branches are present, each branch is represented in a new row with the same pipeline ID, such as illustrated in the data structure of FIG. 4B.

The extracted sub-pipelines are encoded into categorical values 306 for each process pipeline, as noted in FIG. 3. In this stage, an encoder or encode process is generated based on analyzed pipelines. In one or more implementations, a numerical dataset is obtained, where the feature vectors are transformed into numerical values, since most unsupervised machine learning models utilize numerical values. The process pipelines from the analyzed set (which can be defined as a particular project, or scope, etc.) are decomposed into the n-ordered nodes (i.e., stages or steps). In one example, there can be i sub-pipelines, obtained from the original process pipeline. For each unique sub-pipeline, the sub-pipeline is mapped to a numerical value, one example of which is depicted in FIG. 5A. In one or more implementations, this mapping to a numerical value is performed by the encoder. One example of an encoded feature matrix is depicted in FIG. 5B, where not a number (NaN) is injected where there is no corresponding sub-pipeline, and where pipeline IDs 2, 3, 4 and respective sub-pipeline encode values are added, by way of example only.

In one or more embodiments, data-analysis-based similarity evaluation is performed to determine an achievable level of pipeline compression 308, as shown in FIG. 3. In one example, this process involves checking which process pipeline nodes (or sub-pipelines) can be consolidated or merged into, for instance, a common node or joint feature node, with a similarity metric being used. For instance, a similarity matrix can be used to determine whether a particular pipeline node consolidation improves complexity reduction based on a correlation quantity or measure. First, a correlation matrix for process pipelines (including branches) is determined or calculated. In one embodiment, the correlation matrix is generated based on the association of each respective feature vector with a respective numerical value. Based on the information encoded in the correlation matrix, a quantity (e.g., a sum of correlation coefficients/correlation matrix entity (metric), determinative correlation matrix) is determined that is indicative of a similarity between respective nodes (i.e., stages or steps) of the sub-pipelines. In particular, the correlation coefficients can be used to determine the metric value according to the following formula:

similarity/redundant_complexity=sum(correlation_coefficients)/number of pipelines.

For complex processing tasks, the sum of the correlation coefficients can be a replaced with a determinate of correlation matrix: det(correlation_coefficients).

Dimensionality reduction is also predicted or determined based on the determined achievable level of pipeline compression 310, as noted in FIG. 3. In one embodiment, in order to ascertain information for, for instance, forwarding to a user, about the level of dimensionality reduction, a reduction metric is used. The reduction metric can be built or generated to estimate the gain in dimensionality reduction by transforming variables to different space, which can be based on a system entropy calculation widely used in various fields. Generally speaking, entropy can be interpreted as system complexity, and can be described using the following formula:

$$E = a \times ln ( N ) ,$$

where:
a=a constant (Boltzmann constant);
In=natural logarithm; and
N=number of nodes reduced (N0−Nred).

As illustrated in FIG. 3, in one or more embodiments, pipeline processing consolidation 300 further includes initiating consolidating, or recommending consolidating, of selected nodes of the process pipelines. Once a potential complexity reduction is identified, the correlation quantity indicative of similarity between respective nodes (i.e., stages or steps) of sub-pipelines can be used to identify and consolidate (e.g., join or merge) highly-correlated nodes and/or sub-pipelines. For instance, in one embodiment, the correlation quantity indicative of similarity between respective nodes (and/or sub-pipelines) can have a predefined relationship with a correlation threshold for consolidating the nodes (or sub-pipelines) of the process pipelines within the computing environment. In one embodiment, consolidating nodes can include extracting the common nodes and replacing them with a single joint or common node (thereby reducing processing steps across the pipelines within the computing environment). In one or more embodiments, initiating consolidating, or recommending consolidating, of selected nodes of the pipelines can be based on one or more unsupervised machine learning models to, for instance, facilitate clustering or grouping of pipelines based on the feature matrix (similarities). The clustering can be formed using the correlation metric obtained during data-analysis-based similarity evaluation, in one or more embodiments.

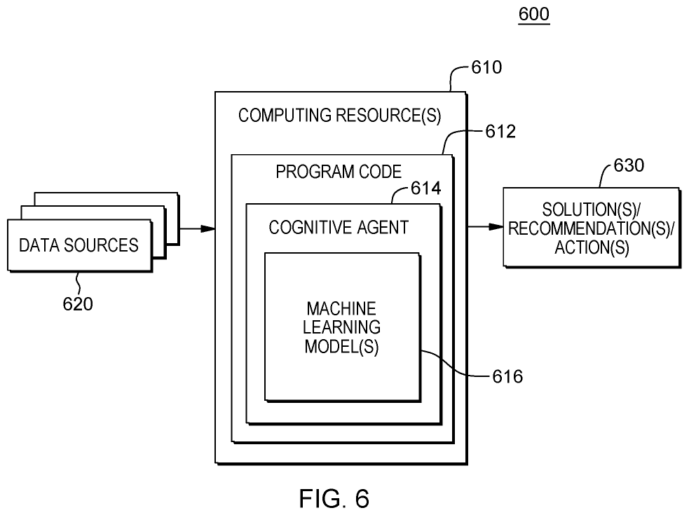

By way of further example, FIG. 6 depicts another embodiment of a computing environment or system 600, which can incorporate, or implement, one or more aspects of an embodiment of the present invention. In one or more implementations, system 600 is implemented as part of a computing environment, such as computing environment 100 described above in connection with FIG. 1. System 600 includes one or more computing resources 610 that execute program code 612 that implements, for instance, one or more aspects of a module or facility, and which includes a cognitive engine or agent 614, which utilizes one or more machine learning models 616, such as described herein. Data, such as process pipeline information or other data discussed herein, is used by cognitive agent 614, to train model(s) 616 to (for instance) facilitate identifying similarity between pipeline nodes, predicting dimensionality reduction, and/or initiating or recommending consolidation of nodes or sub-pipelines and/or other related actions 630, etc., based on the particular application of the machine-learning model to facilitate achieving the pipeline consolidation process. In implementation, system 600 can include, or utilize, one or more networks for interfacing various aspects of computing resource(s) 610, as well as one or more data sources 620 providing data, and one or more systems receiving a consolidation output, action, etc., 630 of machine learning model(s) 616. By way of example, the network(s) can be, for instance, a telecommunications network, a local-area network (LAN), a wide-area network (WAN), such as the Internet, or a combination thereof, and can include wired, wireless, fiber-optic connections, etc. The network(s) can include one or more wired and/or wireless networks that are capable of receiving and transmitting data, including training data for the machine-learning model, and an output solution, recommendation, action, of the machine-learning model, such as discussed herein.

In one or more implementations, computing resource(s) 610 house and/or execute program code 612 configured to perform methods in accordance with one or more aspects of the present invention. By way of example, computing resource(s) 610 can be a computing-system-implemented resource(s). Further, for illustrative purposes only, computing resource(s) 610 in FIG. 6 is depicted as being a single computing resource. This is a non-limiting example of an implementation. In one or more other implementations, computing resource(s) 610, by which one or more aspects of machine-learning-based pipeline processing consolidation, such as discussed herein can, at least in part, be implemented in multiple separate computing resources or systems, such as one or more computing resources of a cloud-hosting environment, by way of example.

Briefly described, in one embodiment, computing resource(s) 610 can include one or more processors, for instance, central processing units (CPUs). Also, the processor(s) can include functional components used in the integration of program code, such as functional components to fetch program code from locations in such as cache or main memory, decode program code, and execute program code, access memory for instruction execution, and write results of the executed instructions or code. The processor(s) can also include a register(s) to be used by one or more of the functional components. In one or more embodiments, the computing resource(s) can include memory, input/output, a network interface, and storage, which can include and/or access, one or more other computing resources and/or databases, as required to implement the machine-learning processing described herein. The components of the respective computing resource(s) can be coupled to each other via one or more buses and/or other connections. Bus connections can be one or more of any of several types of bus structures, including a memory bus or a memory controller, a peripheral bus, an accelerated graphics port, and a processor or local bus, using any of a variety of architectures. By way of example, but not limitation, such architectures can include the Industry Standard Architecture (ISA), the micro-channel architecture (MCA), the enhanced ISA (EISA), the Video Electronic Standard Association (VESA), local bus, and peripheral component interconnect (PCI). As noted, examples of a computing resource(s) or a computer system(s) which can implement one or more aspects disclosed are described further herein with reference to the figures.

In one embodiment, program code 612 executes, in one implementation, a cognitive engine or agent 614 which includes and trains one or more models 616. The models can be trained using training data that can include a variety of types of data, depending on the model and the data sources. In one or more embodiments, program code 612 executing on one or more computing resources 610 applies one or more algorithms of cognitive agent 614 to generate and train the model(s), which the program code then utilizes to identify, for instance, similarity between pipeline nodes and/or sub-pipelines, and to predict dimensionality reduction based on the determined achievable level of pipeline compression, etc., and depending on the application, to perform an action (e.g., initiate or perform node consolidation (i.e., reduction), make a consolidation recommendation, perform a consolidation-based task, etc.). In an initialization or learning stage, program code 612 trains one or more machine learning models 616 using obtained training data that can include, in one or more embodiments, process pipeline files, pipeline node (steps or stages), data, etc., such as described herein.

Data used to train the model (in one or more embodiments of the present invention) can include a variety of types of data, such as heterogeneous data generated by one or more data sources and/or data stored in one or more databases, or accessible by, the computing resource(s). Program code, in embodiments of the present invention, can perform data analysis to generate data structures, including algorithms utilized by the program code to predict and/or perform an action. As known, machine-learning-based modeling solves problems that cannot be solved by numerical means alone. In one example, program code extracts features/attributes from training data, which can be stored in memory or one or more databases. The extracted features can be utilized to develop a predictor function, h(x), also referred to as a hypothesis, which the program code utilizes as a model. In identifying machine learning model(s) 616, various techniques can be used to select features (elements, patterns, attributes, etc.), including but not limited to, diffusion mapping, principal component analysis, recursive feature elimination (a brute force approach to selecting features), and/or a random forest, to select the attributes related to the particular model. Program code can utilize one or more algorithms to train the model(s) (e.g., the algorithms utilized by program code), including providing weights for conclusions, so that the program code can train any predictor or performance functions included in the model. The conclusions can be evaluated by a quality metric. By selecting a diverse set of training data, the program code trains the model to identify and weight various attributes (e.g., features, patterns) that correlate to enhanced performance of the model.

In one or more embodiments, program code, executing on one or more processors, utilizes an existing cognitive analysis tool or agent (now known or later developed) to tune the model, based on data obtained from one or more data sources. In one or more embodiments, the program code can interface with application programming interfaces to perform a cognitive analysis of obtained data. Specifically, in one or more embodiments, certain application programing interfaces include a cognitive agent (e.g., learning agent) that includes one or more programs, including, but not limited to, natural language classifiers, a retrieve-and-rank service that can surface the most relevant information from a collection of documents, concepts/visual insights, tradeoff analytics, document conversion, and/or relationship extraction. In an embodiment, one or more programs analyze the data obtained by the program code across various sources utilizing one or more of a natural language classifier, retrieve-and-rank application programming interfaces, and tradeoff analytics application programing interfaces.

In one or more embodiments of the present invention, the program code can utilize a neural network to analyze training data and/or collected data to generate an operational machine-learning model. Neural networks are a programming paradigm which enable a computer to learn from observational data. This learning is referred to as deep learning, which is a set of techniques for learning in neural networks. Neural networks, including modular neural networks, are capable of pattern (e.g., state) recognition with speed, accuracy, and efficiency, in situations where datasets are mutual and expansive, including across a distributed network, including but not limited to, cloud computing systems. Modern neural networks are non-linear statistical data modeling tools. They are usually used to model complex relationships between inputs and outputs, or to identify patterns (e.g., states) in data (i.e., neural networks are non-linear statistical data modeling or decision-making tools). In general, program code utilizing neural networks can model complex relationships between inputs and outputs and identified patterns in data. Because of the speed and efficiency of neural networks, especially when parsing multiple complex datasets, neural networks and deep learning provide solutions to many problems in multi-source processing, which program code, in embodiments of the present invention, can utilize in implementing a machine-learning model, such as described herein.

Those skilled in the art will note from the provided description that embodiments of the present invention include computer-implemented methods, computer systems and computer program products, where program code executing on one or more processors facilitates processing within a computing environment by determining a correlation quantity indicative of similarity between respective nodes of processing pipelines of the computing environment, and initiating consolidating of the respective nodes of process pipelines based on the correlation quantity having a predefined relationship with a correlation threshold for consolidating nodes of process pipelines within the computing environment. In one or more embodiments, initiating consolidating of the respective nodes of process pipelines proceeds based on the correlation quantity exceeding the correlation threshold for simplifying processing of the process pipelines within the computing environment. Note that, in one or more embodiments, initiating consolidating or merging of the respective nodes can include sending (automatically based on the correlation quantity having the predefined relationship with the correlation threshold) an indication to commence the action. As an example, the action can be initiated by a computer (e.g., computer 101 (FIG. 1)), a processor of a processor set (e.g., processor set 110) and/or processing circuitry of a processor set (e.g., processor set 110), communicating with one or more components or processes of the computing environment which receive the indication and automatically perform the action. Alternatively, or additionally, an indication can be sent to an operator or other entity that oversees the system or environment. Many possibilities exist.

In one or more embodiments, the program code executing on the one or more processors converts each process pipeline into a feature vector of sub-pipelines, with each sub-pipeline including multiple ordered nodes of the process pipeline, where determining the correlation quantity is based, at least in part, on the sub-pipelines.

In one or more embodiments, converting the process pipeline into the feature vector of sub-pipelines includes categorizing the process pipeline into n-ordered nodes of sub-pipelines, where n≥3, and converting the n-ordered nodes of sub-pipelines into the feature vector of sub-pipelines for the process pipeline.

In one or more implementations, the program code executing on the one or more processors further encodes the feature vector of sub-pipelines of each pipeline into respective numerical values, where determining the correlation quantity is based, at least in part, on system analysis of the respective numerical values determined for the process pipelines.

In one or more embodiments, determining the correlation quantity further includes evaluating similarity between respective nodes of sub-pipelines by generating a correlation matrix based on an association of each respective feature vector with its respective numerical values, and evaluating correlation-quantity-based information encoded in the correlation matrix by evaluating similarity between the respective nodes of sub-pipelines.

In one or more embodiments, program code executing on the one or more processors further detects the respective nodes of the process pipelines of the computing environment to consolidate based on similarity between the respective nodes, and determines a dimensionality reduction to the process pipelines of the computing environment based on the subject consolidating of the respective nodes to the process pipelines. In one example, the initiating consolidating is based, at least in part, on the dimensionality reduction achievable with consolidating of the respective nodes of the process pipelines resulting in a processing reduction for the process pipelines within the computing environment.

In one or more embodiments, the program code executing on the one or more processors further pre-processes the multiple process pipelines to remove redundant nodes of the process pipelines.

As noted, the goal of the pipeline consolidation process disclosed herein is to merge or recommend merging of a group of pipelines to simplify the pipeline processing by extracting similar nodes and replacing them with, for instance, a single joint or common node, thereby reducing pipeline processing overhead.

Note that, by default, a sub-pipeline length, represented by parameter n, can be set to 3. In certain cases, a higher value might produce better results in the context of pipeline dimensionality reduction. In such a case, before any processing, the following algorithm can be run to determine a best value for parameter n:
Starting from n=3, incrementally use higher n values and calculate the complexity measure.
If complexity measure is not improving (i.e., there is an increase in complexity), use the prior n parameter value.
If complexity measure improves (i.e., complexity is decaying), assign n as the current value.
If complexity measure rises less than a set threshold, terminate the process.
   As noted, the maximum number for parameter n can depend on the size of the pipelines. Note also that the complexity measure described herein can be considered an entropy lost measurement. Another approach is to adopt a breath-first search algorithm approach to search for a distance from each pipeline to another pipeline, and then take the most common distance as the n value (with certain constraints).

As noted herein, one or more aspects of the present invention disclosed are directed to reducing pipeline complexity. In one embodiment, reducing pipeline complexity can include: pre-processing a pipeline so that non-refining nodes (e.g., input nodes, source data nodes, output nodes, static nodes, etc.) that are redundant in an optimization process are removed. Features are extracted from the pipeline, where each pipeline of a set of pipelines is categorized into n-ordered nodes (i.e., stages or steps) of sub-pipelines, and where the respective n-ordered nodes of sub-pipelines are converted into corresponding respective feature vectors. The feature vectors of sub-pipelines are encoded, where each feature vector is associated with a respective numerical value (e.g., via a mapping from the feature vector to a numerical value). Similarity data analysis is performed between respective nodes of sub-pipelines, where a correlation matrix is generated based on the association of each feature vector with the respective numerical value, and where based on information encoded in the correlation matrix, a correlation quantity (e.g., sum of correlation coefficients/correlation matrix entry (metric), determinant of correlation matrix) is determined that is indicative of a similarity between respective nodes of sub-pipelines. Further, information that is associated with a potential complexity reduction can be obtained, where the correlation quantity indicative of similarity between respective nodes of sub-pipelines is utilized to selectively initiate consolidating or merging of respective nodes of the pipelines to, for instance, join or merge highly-correlated sub-pipelines of the pipelines. Advantageously, in one or more aspects, disclosed herein are processes for quantifying similarity of nodes in different pipelines to facilitate consolidating the nodes, and thereby reduce process overhead and enhance processing within the computing environment. Further, the potential pipeline complexity reduction is quantified in order to, for instance, consolidate or merge nodes of the process pipelines best able to achieve optimal performance.

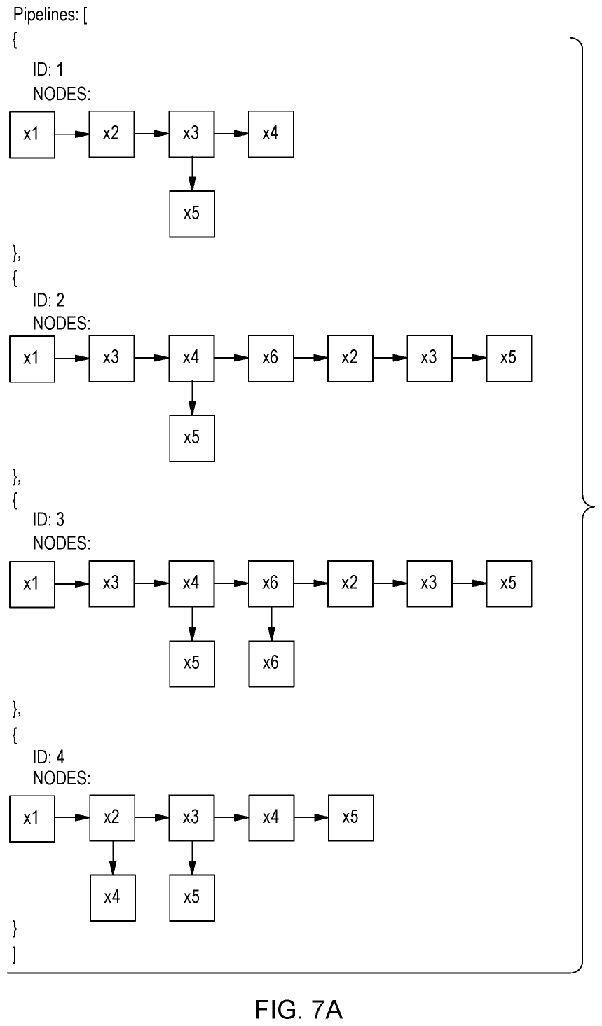

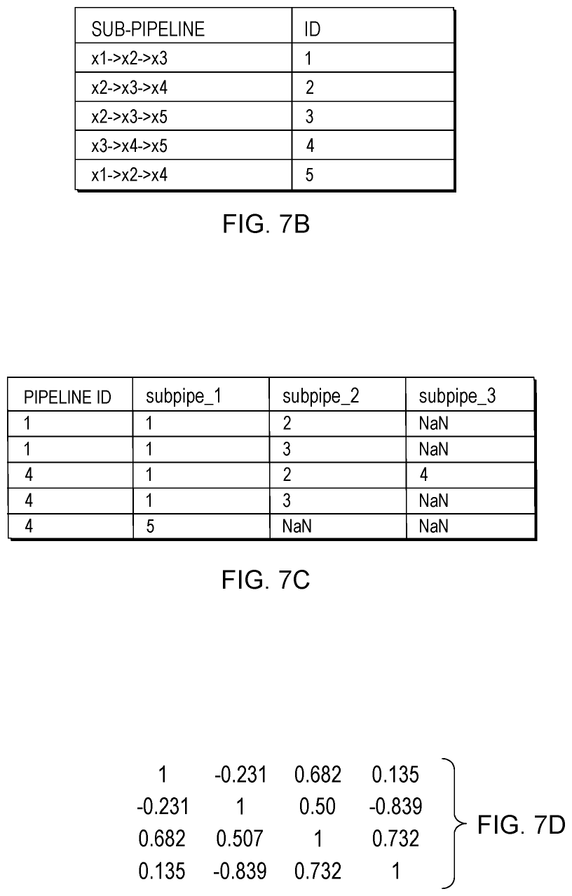

FIGS. 7A-7D depict a further example of pipeline processing consolidation, in accordance with one or more aspects of the present invention. In this example, parameter n is set to 3, defining the length of each sub-pipeline, with one embodiment of already pre-processed pipelines ID 1-ID 4, depicted in FIG. 7A (by way of example).

Using the set of process pipelines of FIG. 7A, feature vectors are extracted based on the n-ordered nodes for each pipeline. As an example, the sub-pipelines for pipeline IDs 1 & 4 are noted below:

Pipeline ID 1 sub-pipelines:
x1→x2→x3
x2→x3→x4
x2→x3→x5

Pipeline ID 4 sub-pipelines:
x1→x2→x3
x2→x3→x4
x3→x4→x5
x1→x2→x4
x2→x3→x5

The extracted sub-pipelines are then encoded into categorical values. In this process, sub-pipeline IDs are assigned for each of the detected sub-pipelines, with only pipelines 1 & 4 being considered in the example. One embodiment of the resultant sub-pipeline IDs is depicted in FIG. 7B. After that, encoding such as described herein is performed to create a feature matrix representing the pipelines. An example of the encoding, considering only pipelines 1 and 4, is illustrated in FIG. 7C.

Data-analysis-based similarity evaluation is performed to determine an achievable level of pipeline compression. For instance, a similarity metric is calculated in order to facilitate joining highly-correlated sub-pipelines of nodes. Once complete, the merged or joined pipelines can be built from the correlated sub-pipelines, with exploratory analysis available using, for instance, the data structures of FIGS. 7B & 7C.

As an example, and not based on the values from the prior steps, assume that the correlation matrix for the pipelines is as depicted in FIG. 7D. For purpose of simplifying the example, the metrics of FIG. 7D were calculated on a sample of artificial data, not connected with the tables of FIGS. 7B & 7C.

Rows and columns represent the pipelines, that is, the i^{th} row in the i^{th} column both represent the i^{th} pipeline, and values in the correlation matrix cell represent the correlation (i.e., similarity) between pipelines. In this regard, ignore cells on the main diagonal, as the same pipeline will always fully correlate to itself (i.e., it contains the same nodes). High values of correlation coefficients in cells other than diagonal, indicate strong correlation between pipelines, and those pipelines contain potential nodes that can be grouped to sub-pipelines for consolidating or reduction. For instance, in this example, assume that there are the following pairs:
Pipeline 1 and Pipeline 3 (coeff_value=0.682)
Pipeline 3 and Pipeline 4 (coeff_value=0.732).

In this example, both have a high correlation coefficient value, and hence, those pipelines contain potential nodes that can be reduced.

For dimensionality reduction evaluation, after detecting potential nodes to reduce, the potential dimensionality reduction metric can be determined. For purpose of simplifying the example, the metrics are assumed to be calculated on a sample of artificial data (again, not connected with the values of FIGS. 7B & 7C). By way of example, dimensionally reduction can be determined as:

Dimensionality reduction (with parameter a=0.5) for:
reduction by 200 nodes and for n=3; e.g. before simplification the process pipelines have 260 nodes, after simplification, there are 60 nodes

$$metric\_value = ( 3 \times 0.5 ) \times ln ( 200 ) = 7.95$$

In another example:
reduction by 50 nodes for n=3 is achieved; e.g., before simplification there are 100 nodes in the pipelines, and after simplification there are 50 nodes. In this case:

$$metric\_value = ( 3 \times 0.5 ) \times ln ( 50 ) = 5.87 .$$

By comparison, there is greater dimensionality reduction with the first example, than the second.

Other aspects, variations and/or embodiments are possible.

The computing environments described herein are only examples of computing environments that can be used. Other environments may be used; embodiments are not limited to any one environment. Although various examples of computing environments are described herein, one or more aspects of the present invention may be used with many types of environments. The computing environments provided herein are only examples.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally, or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer readable code into a computing system, in which the code in combination with the computing system is capable of performing one or more embodiments.

As yet a further aspect, a process for integrating computing infrastructure comprising integrating computer readable code into a computer system may be provided. The computer system comprises a computer readable medium, in which the computer medium comprises one or more embodiments. The code in combination with the computer system is capable of performing one or more embodiments.

Although various embodiments are described above, these are only examples. For example, other types of neural networks may be considered. Further, other scenarios may be contemplated. Many variations are possible.

Various aspects and embodiments are described herein. Further, many variations are possible without departing from a spirit of aspects of the present invention. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method of facilitating processing within a computing environment, the computer-implemented method comprising:
determining a correlation quantity indicative of similarity between respective nodes of process pipelines of the computing environment; and
initiating consolidating of the respective nodes of the process pipelines based on the correlation quantity having a predefined relationship with a correlation threshold for consolidating nodes of process pipelines within the computing environment.

2. The computer-implemented method of claim 1, further comprising for each process pipeline of the process pipelines:
converting the process pipeline into a feature vector of sub-pipelines, each sub-pipeline comprising multiple nodes of the process pipeline, wherein determining the correlation quantity is based, at least in part, on the sub-pipelines.

3. The computer-implemented method of claim 2, wherein converting the process pipeline into the feature vector of sub-pipelines comprises:
categorizing the process pipeline into n-ordered nodes of sub-pipelines, where n≥3; and
converting the n-ordered nodes of sub-pipelines into the feature vector of sub-pipelines for the process pipeline.

4. The computer-implemented method of claim 2, further comprising for each process pipeline of the process pipelines:
encoding the feature vector of sub-pipelines into respective numerical values, wherein determining the correlation quantity is based, at least in part, on an analysis of the respective numerical values determined for the process pipelines.

5. The computer-implemented method of claim 4, wherein the determining further comprises evaluating similarity between respective nodes of sub-pipelines by:
generating a correlation matrix based on an association of each respective feature vector with its respective numerical values; and
evaluating correlation-quantity-based information encoded in the correlation matrix in evaluating similarity between respective nodes of sub-pipelines.

6. The computer-implemented method of claim 1, further comprising:
detecting respective nodes of the process pipelines of the computing environment to consolidate based on similarity between the respective nodes; and
determining a dimensionality reduction to the process pipelines of the computing environment based on a consolidating of the respective nodes of the process pipelines.

7. The computer-implemented method of claim 6, wherein the initiating consolidating is based, at least in part, on the dimensionality reduction achievable with consolidating of the respective nodes of the process pipelines resulting in a processing reduction for the process pipelines within the computing environment.

8. The computer-implemented method of claim 1, wherein initiating consolidating of the respective nodes of the process pipelines proceeds based on the correlation quantity exceeding the correlation threshold for simplifying processing of the process pipelines within the computing environment.

9. The computer-implemented method of claim 1, further comprising pre-processing the multiple process pipelines to remove redundant nodes of the process pipelines.

10. A computer system for facilitating processing within a computing environment, the computer system comprising:
a memory; and
at least one processor in communication with the memory, wherein the computer system is configured to perform a method, the method comprising:
determining a correlation quantity indicative of similarity between respective nodes of process pipelines of the computing environment; and
initiating consolidating of the respective nodes of the process pipelines based on the correlation quantity having a predefined relationship with a correlation threshold for consolidating nodes of process pipelines within the computing environment.

11. The computer system of claim 10, further comprising for each process pipeline of the process pipelines:
converting the process pipeline into a feature vector of sub-pipelines, each sub-pipeline comprising multiple nodes of the process pipeline, wherein determining the correlation quantity is based, at least in part, on the sub-pipelines.

12. The computer system of claim 11, wherein converting the process pipeline into the feature vector of sub-pipelines comprises:
categorizing the process pipeline into n-ordered nodes of sub-pipelines, where n≥3; and
converting the n-ordered nodes of sub-pipelines into the feature vector of sub-pipelines for the process pipeline.

13. The computer system of claim 11, further comprising for each process pipeline of the process pipelines:
encoding the feature vector of sub-pipelines into respective numerical values, wherein determining the correlation quantity is based, at least in part, on an analysis of the respective numerical values determined for the process pipelines.

14. The computer system of claim 13, wherein the determining further comprises evaluating similarity between respective nodes of sub-pipelines by:
generating a correlation matrix based on an association of each respective feature vector with its respective numerical values; and
evaluating correlation-quantity-based information encoded in the correlation matrix in evaluating similarity between respective nodes of sub-pipelines.

15. The computer system of claim 11, further comprising:
detecting respective nodes of the process pipelines of the computing environment to consolidate based on similarity between the respective nodes; and
determining a dimensionality reduction to the process pipelines of the computing environment based on a consolidating of the respective nodes of the process pipelines.

16. The computer system of claim 15, wherein the initiating consolidating is based, at least in part, on the dimensionality reduction achievable with consolidating of the respective nodes of the process pipelines resulting in a processing reduction for the process pipelines within the computing environment.

17. A computer program product for facilitating processing within a computing environment, the computer program product comprising:
one or more computer-readable storage media and program instructions collectively stored on the one or more computer-readable storage media readable by at least one processing circuit to perform a method comprising:
determining a correlation quantity indicative of similarity between respective nodes of process pipelines of the computing environment; and
initiating consolidating of the respective nodes of the process pipelines based on the correlation quantity having a predefined relationship with a correlation threshold for consolidating nodes of process pipelines within the computing environment.

18. The computer program product of claim 17, further comprising for each process pipeline of the process pipelines:
converting the process pipeline into a feature vector of sub-pipelines, each sub-pipeline comprising multiple nodes of the process pipeline, wherein determining the correlation quantity is based, at least in part, on the sub-pipelines.

19. The computer program product of claim 18, wherein converting the process pipeline into the feature vector of sub-pipelines comprises:
categorizing the process pipeline into n-ordered nodes of sub-pipelines, where n≥3; and
converting the n-ordered nodes of sub-pipelines into the feature vector of sub-pipelines for the process pipeline.

20. The computer program product if claim 18, further comprising for each process pipeline of the process pipelines:
encoding the feature vector of sub-pipelines into respective numerical values, wherein determining the correlation quantity is based, at least in part, on an analysis of the respective numerical values determined for the process pipelines.
